(19) United States
(12) Patent Application Publication
(10) Pub. No.: US 2025/0156231 A1
(43) Pub. Date: May 15, 2025

(54) DYNAMIC NODE RESOURCE MANAGEMENT

(71) Applicant: Blockjoy, Inc., Boston, MA (US)

(72) Inventors: Sean Carey, Boston, MA (US); Christopher Bruce, Boston, MA (US)

(73) Assignee: Blockjoy, Inc., Boston, MA (US)

(21) Appl. No.: 18/836,100

(22) PCT Filed: Mar. 27, 2023
(86) PCT No.: PCT/US23/64980

§ 371 Date: Aug. 6, 2024

Related U.S. Application Data
(60) Provisional application No. 63/323,987, filed on Mar. 25, 2022.

(51) Int. Cl. G06F 9/50; G06F 9/455; H04L 9/00

(52) U.S. Cl. CPC G06F 9/5038; G06F 9/45541; G06F 9/45558; H04L 9/50

(57) ABSTRACT

In variants, a node resource management system, determine which of a set of managed blockchain nodes are participants in a blockchain event for the respective node's blockchain; and preferentially allocating computing resources, shared by the set of managed blockchain nodes, to the participating managed nodes.

### CROSS-REFERENCE TO RELATED APPLICATIONS

This application claims the benefit of U.S. Provisional Application No. 63/323,987 filed 25 Mar. 2022, each of which is incorporated in its entirety by this reference.

### TECHNICAL FIELD

This invention relates generally to the blockchain field, and more specifically to a new and useful node management system and/or method in the blockchain field.

### BRIEF DESCRIPTION OF THE FIGURES

FIG. 1 is a flowchart representation of a variant of the method.

FIG. 2 is a schematic representation of a variant of the system.

FIG. 3 is a flowchart representation of an example of the method.

FIG. 4 is a flowchart representation of a second example of the method.

FIG. 5 is a schematic representation of a third example of the method.

FIG. 6 is a schematic representation of an illustrative example of the method.

FIG. 7 is a schematic representation of a fourth example of the method.

FIG. 8 is an illustrative example of the information tracked for each managed node.

### DETAILED DESCRIPTION

The following description of the embodiments of the invention is not intended to limit the invention to these embodiments, but rather to enable any person skilled in the art to make and use this invention.

### 1. Overview

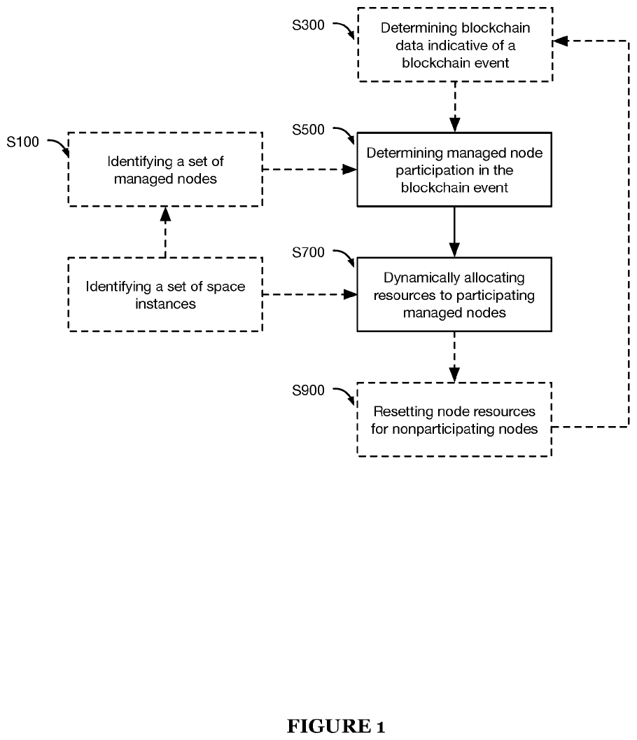

As shown in FIG. 1, the method for blockchain node management can include: identifying a set of managed nodes S100; determining blockchain data indicative of a blockchain event S300; determining managed node participation in the blockchain event S500; dynamically allocating resources to the participating managed nodes S700; and resetting node resources for nonparticipating nodes S900. The method functions to dynamically allocate resources to nodes participating in resource-intensive blockchain events, and optionally de-allocate resources from nonparticipating nodes.

### 2. Technical Advantages.

The inventors have discovered that blockchain nodes need different amounts of computing resources at different times, based on the node's current role in its respective blockchain network. For example, nodes that are participating in block validation consume—and under some blockchain protocols, require-vastly more computing resources than those at rest. However, resource underallocation can also be detrimental. For example, under some protocols, under-allocation of computing resources to a node may cause the node to never be elected for participation in key blockchain events (e.g., consensus), or could lead to loss of stakes, tokens, authority, and/or other assets.

To mitigate this risk, node hosts conventionally reserve the full computing resources required for validation. This wastes a lot of power and computing resources, since the nodes are always running at maximum output. This is also extremely costly, since most of these nodes are being run on cloud computing management systems that charge based on the amount of reserved computing resources.

Furthermore, conventional resource management systems cannot be used to solve this problem, because conventional systems operate at the machine instance level (e.g., dynamically spool machine instances up or down). This is untenable for blockchain-based applications, because spooling down the “resource” (the machine) would require shutting the node down completely, which means that the node would never have an opportunity to be a participant, as it is never online during participant election or blockchain event execution.

In contrast, this technology resolves the resource allocation issue by continuously running multiple nodes on shared computing resources (e.g., a single machine, a computing resource pool, etc.), by introspecting the blockchain to determine whether each managed node will participate in a resource-consuming blockchain event, and dynamically allocating computing resources to the node based on current and/or anticipated node participation in the blockchain event (e.g., by setting the process priority for the node). Because each node is not running at maximum output, the nodes can share computing resources from the same machine, thereby allowing more nodes to be hosted by a single machine, while still enabling the nodes to run at maximum performance when necessary. This allows for the same number of nodes to be hosted by less machines, which leads to lower overall resource, energy, and cost consumption. As an illustrative example, this technology can reduce the load average for a managed blockchain node by more than half (e.g., from 100 to 30 or 20).

However, further advantages can be provided by the management system and method disclosed herein.

3. Illustrative examples.

In an example, a management system 100, managing a set of managed nodes executing on a set of computing resources, can be configured to: determine which of the managed nodes are participants in a blockchain event (e.g., consensus) for the respective node's blockchain; and preferentially allocating computing resources to the participating managed nodes.

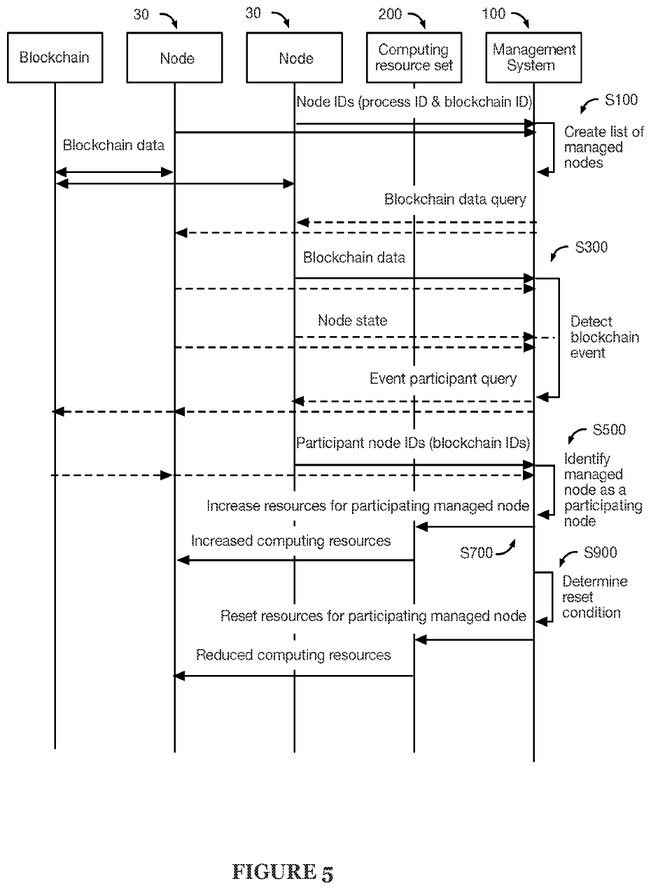

In a second example, the method includes: identifying a set of managed nodes sharing computing resources; detecting a blockchain event by introspecting the blockchain (e.g., using the managed nodes or a blockchain explorer); determining which managed nodes of the set are participating in the blockchain event; dynamically allocating more of the shared computing resources to the participating nodes (e.g., by increasing the node's process priority; by setting the node's process priority to −10; etc.); maintaining the increased resource allocation to the participating nodes throughout the blockchain event; and decreasing the amount of shared computing resources allocated to the previously-participating nodes after the blockchain event (e.g., by decreasing the node's process priority to a default value; etc.). An example is shown in FIG. 5

However, the method can be otherwise performed.

### 4. System.

The system 10 can include one or more management systems 100, which function to dynamically allocate resources to blockchain nodes based on blockchain event participation. The system 10 can optionally include or be used with a set of computing resources 200, a set of blockchain nodes 30, and/or any other suitable set of components.

The management system 100 can be used with one or more blockchain networks. Each blockchain network can include a decentralized network of blockchain nodes where consensus nodes (e.g., validators, confirmation nodes, proposal nodes, etc.) validate blocks according to the consensus mechanism for the blockchain's protocol. The blockchains used with this system are preferably blockchains where consensus is not race-based (e.g., proof of work) and/or are blockchains that algorithmically select (e.g., elect, nominate, etc.) consensus nodes (e.g., validator nodes; for each of a set of validation epochs or timeframes), but can alternatively be race-based, consensus blockchains. Example consensus mechanisms used by the blockchains can include one or more of: proof of work, proof of stake, delegated proof of stake, proof of validity, proof of activity, proof of burn, proof of capacity (e.g., wherein the management system dynamically allocates more storage space to the node when the node is elected as a validator), proof of memory, proof of contribution, proof of history, proof of importance, proof of replication, proof of spacetime, byzantine fault tolerance (e.g., practical BFT, Istanbul BFT, federated BFT, etc.), proof of elapsed time, and/or any other suitable consensus mechanism using any other suitable basis. The blockchains can be UTXO blockchains, account-based blockchains, and/or any other suitable type of blockchain. Examples of blockchains that can be used with this system include: Helium, Solana, Ethereum 2.0, Algorand, Avalanche, Cardano, Hyperledger, Cronos, Cosmos, Bitcoin, Polkadot, and/or other blockchains.

The blockchain nodes 30 are preferably connected to, synchronized with, and function to interact with the respective blockchain, but can be otherwise constructed. Each blockchain node is preferably part of (e.g., connected to, synchronizes with, etc.) a single blockchain, but can alternatively be connected to multiple blockchains. The blockchain nodes can be full nodes (e.g., storing all blocks, storing the N most recent blocks, etc.), partial nodes, and/or any other suitable node. The blockchain nodes are preferably consensus nodes (e.g., validation nodes, mining nodes, block proposal nodes, block voting nodes, etc.), but can alternatively be any other suitable node. Examples of full nodes that can be used include: pruned nodes, archival full nodes (e.g., mining nodes, staking nodes, authority nodes, master nodes, etc.), and/or any other full node. However, any other set of blockchain nodes can be used.

Each blockchain node 30 can be associated with one or more blockchain accounts, and access the keys associated with each account. The blockchain node can store the keys directly (e.g., in an encrypted store), be connected to a hardware wallet, store the keys in a secret store, and/or otherwise access the keys. The keys can be: private keys, participation keys (e.g., keys used to participate in the event, keys used to prove participation in the event, etc.), event keys (e.g., keys used to perform actions during the event), and/or any other suitable set of keys. The keys can be received from a user, generated by the node (e.g., using a random function, such as VRF; using a key generation ceremony; etc.), and/or otherwise accessed by the node.

The blockchain nodes 30 can participate in one or more blockchain activities on the respective blockchain (e.g., be participating nodes). Blockchain activities can include blockchain events and/or other network-wide blockchain activity. Examples of blockchain events can include: consensus (e.g., block generation, block validation, etc.), participant selection (e.g., selecting which blockchain nodes will participate in the next action round), key generation, and/or any other suitable event. Examples of consensus can include: block generation (e.g., mining, block proposal, block authoring, etc.), block validation (e.g., block voting, block certification, etc.), and/or other valid-block-generation events.

The events are preferably performed on-chain (e.g., on-chain events), but can alternatively be performed offchain. The events are preferably performed by a set of participants (e.g., participating nodes), but can additionally or alternatively be performed by oracles and/or other management systems. The participants are preferably a subset of all nodes within the blockchain network, but can alternatively be all nodes within the blockchain network, a single node, and/or any other suitable number of nodes. Participation can include: generating a proof, staking assets, performing computations, membership in a pool (e.g., a staking pool), and/or otherwise participating in the blockchain event. The blockchain event can occur: periodically (e.g., at a predetermined frequency, at the block generation rate, etc.), when a blockchain condition is met (e.g., the number of unvalidated transactions exceeds a threshold), and/or at any other suitable time.

All, a subset, or a predetermined number of blockchain nodes 30 on a given blockchain can participate in each blockchain event instance. The blockchain nodes participating in a blockchain event instance (e.g., “participating nodes”) can be: randomly selected, selected based on satisfaction of a condition, elected, and/or otherwise determined. The participating nodes are preferably determined according to the blockchain's consensus mechanism and/or consensus algorithm, but can be otherwise determined. The nodes participating in a given blockchain event instance can be identified: from a participating node list generated by the blockchain, by querying each blockchain node to determine the node's participation state, and/or otherwise determined.

The blockchain nodes 30 can additionally or alternatively perform one or more blockchain actions (e.g., in addition to or instead of blockchain event participation) on the respective blockchain. Examples of other blockchain actions can include, synchronizing the blockchain (e.g., synchronizing the blocks from the blockchain), synchronizing the transactions (e.g., verified or unverified transactions), broadcasting transactions to the blockchain, asset staking, and/or other blockchain interactions. The blockchain nodes performing the blockchain action can be determined as discussed above for blockchain event participation, or be otherwise determined.

The blockchain nodes 30 can also enable off-chain management systems to interact with the blockchain. For example, off-chain management systems can: read the blockchain state from the node, query the blockchain and/or other nodes via the node, submit transactions to the blockchain via the node, and/or otherwise interact with the node.

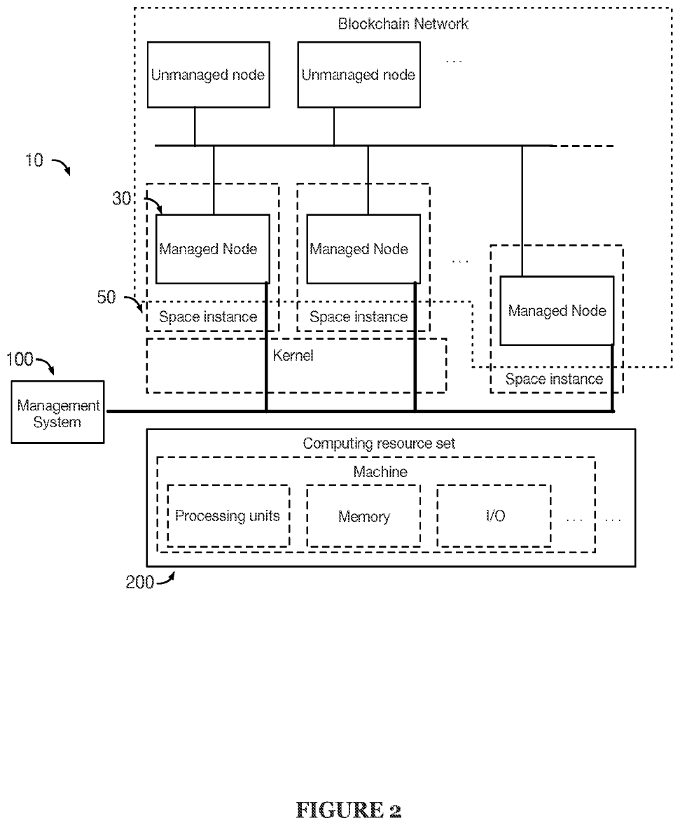

The system 10 can interact with one or more blockchain nodes 30, example shown in FIG. 2. The blockchain nodes can be managed nodes or unmanaged nodes. Unmanaged nodes can be nodes outside of management system control. Managed nodes can be controlled by the management system, wherein the management system can control node execution, node prioritization (e.g., process prioritization), resource allocation, and/or other node aspects. Managed nodes can be: nodes that are hosted on (e.g., run on, executed by, etc.) computing resources managed by the management system; nodes executing in space instances controlled by the management system (e.g., wherein the system can include a daemon or agent controlling space instance operation; include a daemon or agent within each space instance; etc.); nodes registered to a control plane interfacing with the management system (e.g., nodes with a known process identifier or node identifier); nodes associated with a user account (e.g., wherein the user account is associated with the space instance or machine); and/or any other suitable node.

In variants, the blockchain nodes 30 (e.g., managed nodes) can be run as processes within space instances 50 (example shown in FIG. 2), but can alternatively be run without space instances, be run on a partition, and/or be run on any other suitable computing environment. Each space instance 50 preferably hosts a single node, but can alternatively host multiple nodes of the same or different type (e.g., same or different blockchain, same or different node class, etc.). A space instance functions to create an isolated virtual space (e.g., isolated environment) that computing processes can be run within, which enables multiple computing processes (e.g., multiple nodes) to be run on a shared (e.g., single) machine. Examples of space instances include: a unikernel, a container (e.g., Docker, Podman, etc.), zone (e.g., Solaris container), virtual private server (e.g., Open VZ), partition, virtual machine, virtual environment, virtual kernel (e.g., DragonFly BSD), jail (e.g., FreeBSD jail, chroot jail, etc.), and/or any other space instance. A single computing resource set preferably supports (e.g., runs) multiple space instances, wherein each space instance preferably supports (e.g., runs) a single node. Alternatively, each computing resource set can support a single space instance, and/or each space instance can support multiple nodes.

The system 10 can include or be used with one or more computing resource sets 200, which functions to host one or more blockchain nodes 30. Hosting a blockchain node can include executing the blockchain node, running the blockchain node, and/or otherwise host the blockchain node. The computing resource set (e.g., shared computing resources) is preferably shared between the one or more blockchain nodes, but can be reserved for a blockchain node, or be otherwise allocated between the one or more blockchain nodes. Each computing resource set can concurrently support (e.g., host, execute, run): one or more nodes, one or more space instances, one or more kernels, and/or one or more virtual computing environments. The blockchain nodes sharing a computing resource set can be of the same or different: blockchain, node type (e.g., full node, partial node, consensus node, etc.), and/or be otherwise related. In variants, the system is agnostic to the combination of blockchain nodes hosted by a single computing resource set; any combination of blockchain nodes can be hosted and managed using the same system.

Different computing resource sets can have the same set of computing resources or different computing resources. Different computing resource sets managed by the same or different management system can be geographically distributed, geographically collocated, be provided by the same or different cloud providers, and/or be otherwise related or unrelated.

The computing resource sets 200 are preferably managed using the management system 100, wherein the management system 100 controls computing resource allocation to different blockchain nodes sharing a computing resource set, but can be otherwise used by the system. The management system 100 can directly control computing resource allocation, indirectly control computing resource allocation (e.g., instruct a third party that directly controls the computing resource set to change the allocation), and/or otherwise control computing resource allocation.

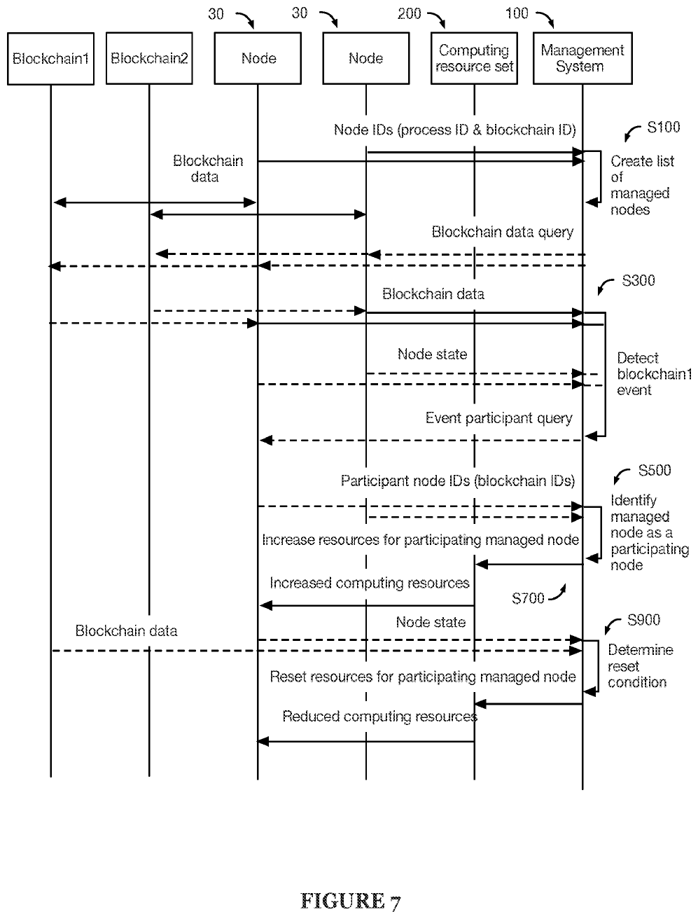

Each computing resource set 200 can be shared by one or more blockchain nodes (e.g., of the same or different blockchains, example shown in FIG. 7), one or more user accounts (e.g., controlling different blockchain nodes), and/or otherwise shared. Additionally or alternatively, the computing resource set can be specific to a blockchain, specific to a user account, and/or otherwise limited.

The computing resources (e.g., management system resources) allocated to the nodes can be physical resources, virtual resources (e.g., virtualized versions of the physical resources, etc.), and/or any other suitable computing resource. Examples of virtual resources can include: virtual processing units (e.g., vCPU, vGPU, etc.), virtual memory (e.g., vRAM, vHD, vLUN, etc.), and/or any other suitable virtualized computing resource. Each virtualized computing resource can map to one or more physical computing resources, and each physical computing resource can map to one or more virtualized computing resources.

The computing resources can be compressible or noncompressible. Examples of computing resources (e.g., management system resources) that can be provided can include: processing resources (e.g., % processing power, number of threads, number of cores, processor time, etc.), memory (e.g., addresses, blocks, memory locations, cache space, contiguous free space, management system memory, etc.), IRW lines, MDA channels, port-mapped I/O, memory-mapped I/O, I/O operations, locks, network throughput (e.g., within the machine itself, Internet bandwidth, etc.), power, sockets, and/or other computing resources. The computing resources can be allocated based on: process priority (e.g., node priority), be explicitly set to an explicit value (e.g., by a profile, by the management system, etc.), and/or otherwise allocated. Computing resource allocation can be controlled by: the management system, a kernel (e.g., that the space instances hosting the nodes is being executed on); a hypervisor (e.g., a type 1 hypervisor, a type 2 hypervisor, etc.), and/or any other suitable resource manager.

The computing resource set 200 can be provided by: a single machine (e.g., server, bare metal machine, etc.), multiple machines (e.g., multiple bare metal machines, a cluster, etc.), and/or by any other suitable number of machines.

The machines function to provide computing resources to managed nodes. The machines are preferably bare metal machines, but can alternatively be virtual resources. The machines can include: processing units (e.g., microprocessors, CPU, GPU, TPU, ASICS, FPGAs, etc.), memory (e.g., volatile memory, nonvolatile memory, cache, management system memory, etc.), and/or any other suitable component. The machines can be local machines (e.g., on-prem machines, laptops, mining rigs, etc.), remote machines (e.g., provided by a cloud service provider), and/or any other machine. The remote machines can be controlled by the management system (e.g., by a management system account); by the user (e.g., by a user account), wherein the management system can access the user's machines using credentials, such as access tokens, provided by the user; by a third party, and/or by any other suitable entity. The system can concurrently or serially interface with one or more machines of the same or different type. The processes executing on a given machine can be associated with (e.g., reserved by) the same or different user (e.g., user account).

The management system 100 for node resource allocation functions to allocate computing resources to managed blockchain nodes, and can additionally or alternatively perform any other suitable functionality. The management system can preferentially allocate computing resources, dynamically allocate computing resources, statically allocate computing resources, and/or allocate computing resources in any other suitable manner. The management system can allocate the computing resources using the method discussed below, but can otherwise allocate the computing resources.

All or portions of the management system 100 can allocate resources to the node by: adjusting the priority (e.g., node priority, space instance priority, etc.), allocating an explicit amount of computing resources (e.g., to the node, to the space instance, etc.), and/or otherwise allocating the computing resources. The computing resources can be allocated relative to other managed nodes (e.g., preferential allocation), be allocated using an explicit value, be allocated relative to a node parameter, or otherwise allocated. In a first example, more computing resources are allocated by increasing the priority above a threshold value, and less computing resources are allocated by decreasing the priority below a threshold value (e.g., the same or different from the increased allocation threshold). In a second example, more computing resources are allocated by setting the priority to a predetermined value and less computing resources are allocated by setting the priority to a second predetermined value (e.g., lower than the first). In a third example, more computing resources are allocated by increasing the priority above a predetermined proportion of the other managed nodes (e.g., above 80% of other nodes) and less computing resources are allocated by decreasing the priority below a second proportion of the other managed nodes (e.g., same or different threshold proportion). In a fourth example, computing resources are allocated (e.g., iteratively) until the node health or node performance (e.g., determined based on the node performance values) satisfies a target. In a fifth example, computing resources are allocated by allocating an explicit amount of computing resources to the node (e.g., the process, the space instance, etc.). The explicit amount can be: a default value (e.g., for all blockchains, for the node's blockchain, for the node type, etc.), a calculated value (e.g., calculated based on historic participating node resource consumption, calculated based on blockchain participation's anticipated return, calculated based on the probability of the node being selected for participation, etc.), the maximum amount that the management system can allocate to the node, and/or be any other suitable amount. However, the resources can be otherwise allocated.

The management system 100 for dynamic node resource allocation can include: a node indexer, a node state module, and a set of blockchain event modules, and can optionally include a space instance indexer, a reset module, and/or any other suitable module. However, the management system can include any other suitable set of modules. The management system can be centralized or decentralized. The management system can be used by node managers, node providers, and/or any other suitable entity. An instance of the management system can be specific to a blockchain, a node type, a set of machines, and/or otherwise specific. Alternatively, a management system instance can manage multiple blockchains, node types, computing resource sets, and/or other components. Different users (e.g., user accounts) can share a common management system instance (e.g., wherein the management system instance manages nodes owned by different users), or have a dedicated management system instance. Each management system instance can manage one or more nodes (e.g., as processes executing in individual space instances) across one or more machines. In variants, the management system can function as a hypervisor (e.g., a type 1 hypervisor, a type 2 hypervisor, etc.), as a supervisor, as an agent, and/or as any other suitable resource manager. All or portions of the management system are preferably separate from the space instances, but can alternatively run within the space instances.

The node indexer functions to identify all managed nodes (e.g., processes) that are managed by a management system instance, and can create a list, registry, database, or other record of the managed nodes (e.g., a list of node identifiers, process identifiers, etc.). The node indexer can index each node's: blockchain, blockchain node identifier (e.g., address, address associated with a private key, hash of the machine identifiers, etc.), process identifier for the node, the space instance identifier for the node, machine identifiers associated with the node (e.g., IP address, port number, machine name, host name, ISP, country, etc.), and/or any other suitable identifier. The managed nodes are preferably live nodes (e.g., currently connected to the respective blockchain networks), but can additionally or alternatively be dormant nodes (e.g., not connected to the respective blockchain networks). The node indexer can execute periodically, continuously, and/or at any other time. The management system preferably includes a single node indexer for all nodes managed by the management system instance, but can alternatively include different node indexers for different blockchains, computing resource sets, and/or other node subgroups.

In a first variant, the nodes, space instances hosting the nodes, agents managing the nodes or space instances, and/or other process can register the node with the node indexer: upon startup, periodically (e.g., provide a heartbeat signal), and/or at any other suitable time, wherein the node indexer generates the set of managed nodes based on the registrations.

In a second variant, the node indexer queries each space instance for the nodes managed by the respective space instance, and generates the set of managed nodes based on the reported nodes.

In a third variant, the node indexer queries the machines for processes consuming or requesting computing resources, identifies processes associated with the nodes (e.g., based on process names associated with the node, based on the amount of computing resources that are consumed, based on the rate of computing resource consumption, etc.), and generates the set of managed nodes based on the node-associated processes.

However, the node indexer can otherwise generate the set of managed nodes.

The optional space instance indexer functions to identify all space instances, that are managed by a management system instance, and can create a list or database of managed space instances. The space instance indexer can optionally create a mapping between the nodes and each space instance. The management system preferably includes a single space instance indexer for all space instances managed by the management system instance, but can alternatively include a different space instance indexer for different space instance types (e.g., one for Docker containers, another for containerd containers, etc.). The space instance indexer can index: the space instance's identifier (e.g., container identifier), machine identifier (e.g., IP address, machine name, host name, ISP, country, etc.), the space instance's process identifier, the one or more nodes hosted within the space instance, and/or any other suitable information. The space instance indexer can operate in a similar manner to the node indexer, wherein the space instance identifier is indexed instead of the node identifier, but can otherwise index the space instances. For example, the space instance itself and/or an agent managing the space instance can register the space instance with the space instance indexer.

The node state module functions to determine node parameter values, which can be used to determine node participation in a blockchain event and/or the probability of participation. The node parameters can include the node's: block height, node stability, last synchronization with the blockchain, staked amount, network version, last participation in a blockchain event, analyses of alerts emitted by the node (e.g., alert types, frequencies, payloads, etc.), node health metrics (e.g., connectivity metrics, node sync status, node peer connectivity, internal health, etc.), computing resource demand (e.g., over a prior time window), and/or any other node parameter. The node state can be determined by: querying the node for the node parameter values, by monitoring the node outputs (e.g., emitted alerts, notifications, etc.), by querying another node connected to the same blockchain (e.g., to determine the blockchain network's parameter values for node parameter value comparison), and/or otherwise determining the node state. The management system preferably includes a single node state module for all blockchain nodes managed by the management system instance (e.g., wherein the node state module can selectively generate the node state queries based on the node's respective blockchain protocol, etc.), but can alternatively include a different node state module for different blockchains (e.g., one for Bitcoin, another for Ethereum, etc.), different node types (e.g., one for full nodes, another for partial nodes, etc.), and/or otherwise different nodes.

The set of blockchain event modules function to determine blockchain data, which can be used to detect the blockchain event, predict when the blockchain event will happen, identify participating nodes (e.g., participating in the blockchain event), and/or otherwise used. One or more blockchain event modules can optionally dynamically allocate or de-allocate resources to nodes. All or portions of the blockchain event modules can be shared across all blockchain nodes managed by the management system instance (e.g., wherein the management system includes a single blockchain event module, wherein the blockchain event module can selectively generate the blockchain event queries based on each node's respective blockchain protocol, etc.), be specific to a blockchain (e.g., specific to each layer 1 blockchain, specific to each layer 2 blockchain, specific to the blockchain type, etc.), specific to a set of related blockchains (e.g., one blockchain event module for all blockchains sharing a common layer 1 blockchain), specific to each node, or be otherwise configured.

The blockchain event is preferably a network event, but can alternatively be an external event or be any other event (e.g., block synchronization, transaction synchronization, etc.). Examples of network events include: consensus (e.g., block proposal, block validation, block voting, block confirmation, distributed key generation, etc.); node selection for consensus (e.g., selecting node participants for the network event); key generation; and/or any other network-wide event. Examples of external events can include: transaction submissions, blockchain state queries, and/or any other interaction between off-chain management systems and the node.

The blockchain event modules can include: an event indexer, an event monitor, a participating node monitor, and/or any other module. The management system can include one or more blockchain event module sets (e.g., one for all nodes, one for each node, etc.).

The event indexer (e.g., “DKG follower”) can determine when the next blockchain event will occur and/or determine whether the blockchain event is currently occurring. In a first variant, the event indexer can query the node at a constant or variable rate (e.g., dependent on block—or temporal-proximity to the next blockchain event) to request event signals indicative of when the next blockchain event will occur from the blockchain or the node itself. For example, the event indexer can determine the time or block identifier for the next consensus from the blockchain node(s) or the blockchain logs (e.g., timeseries of blockchain events). In a second variant, the event indexer can include a timer, and determine that a blockchain event will occur when a threshold time has passed. This can be particularly useful for blockchains where consensus occurs at a predetermined frequency (e.g., Cardano, etc.). However, the event indexer can be otherwise configured.

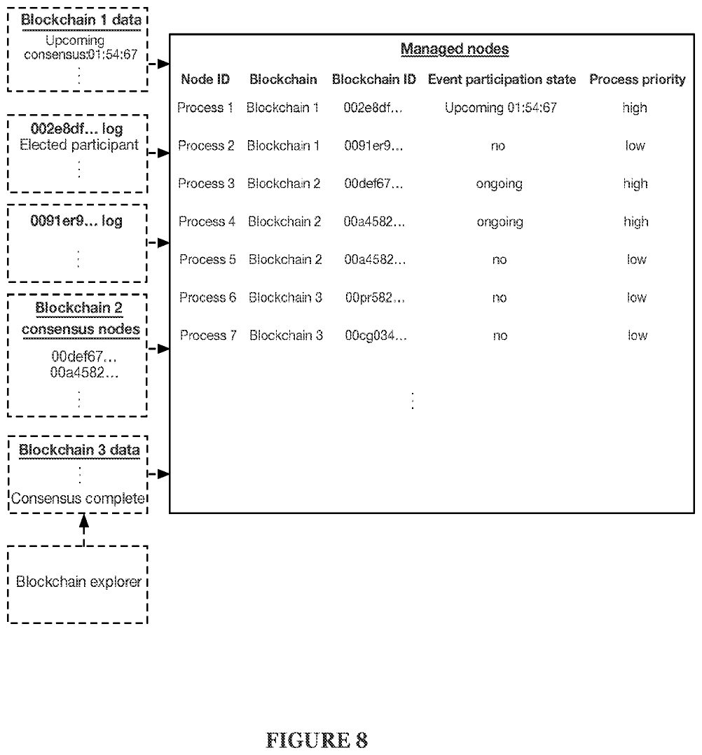

The event monitor (e.g., “DKG monitor”) can determine whether a node is selected as a participant in the blockchain activity (e.g., blockchain event), and can dynamically increase computing resource allocation to the node based on node participation. The event monitor preferably determines whether the node is a participant in an upcoming blockchain event, but can additionally or alternatively determine whether the node is a participant (e.g., remains a participant) within an ongoing blockchain event, whether the node was a participant in a past blockchain event, and/or determine node participation in any other suitable blockchain event (e.g., example of node event participation tracking shown in FIG. 8).

In a first variation, the event monitor can request the set of blockchain event participants from node(s) connected to the blockchain (e.g., managed nodes, unmanaged nodes, etc.), and determine whether any of the managed nodes are participating nodes (e.g., participant nodes; appear in the participant set). For example, the event monitor can request a list of consensus participants (e.g., validators, block proposers, etc.) from the respective blockchain, then determine whether any managed nodes (e.g., determined by the node indexer) appear in the list (e.g., by comparing the lists, determining an intersection of the list, etc.).

In a second variation, the event monitor can obtain the blockchain event participant set from an offchain source, such as a blockchain explorer, and identify the managed nodes participating in the blockchain event as discussed above.

In a third variation, the event monitor can query each monitored node to determine the node's participation state. For example, the event monitor can query a node to determine whether the node is acting as an event participant or has been selected as an event participant.

In a fourth variation, the event monitor can determine the node participation states based on the blockchain data. For example, the event monitor can determine that all managed nodes of a given blockchain are nonparticipants when the blockchain's event has ended.

However, the event monitor can otherwise determine node participation in the blockchain event.

The participating node monitor (e.g., “CG monitor”) can determine whether a node is participating in the blockchain event (e.g., is in the consensus group, is validating a block, etc.), and can maintain or dynamically increase computing resource allocation to the node based on node participation. The participating node monitor can be part of the event monitor, or be a separate component. In variants, the event monitor can determine whether a node will be a participant in an upcoming event, while the participating node monitor determines whether the node is still a participant in an ongoing event; alternatively, the roles can be switched and/or be otherwise configured. The participating node monitor can monitor node participation by: evaluating the node's parameter values, evaluating the node health, evaluating how the participating monitored node is performing relative to other participating nodes of the same blockchain, and/or otherwise monitoring participating monitored node (e.g., example of node event participation tracking shown in FIG. 8).

In a first variation, the participating node monitor can request the set of blockchain event participants from node(s) connected to the blockchain (e.g., managed nodes, unmanaged nodes, etc.), and determine whether any of the managed nodes are participating nodes (e.g., participant nodes; appear in the participant set). For example, the participating node monitor can request a list of consensus participants (e.g., validators, block proposers, etc.) from the respective blockchain, then determine whether any managed nodes (e.g., determined by the node indexer) appear in the list (e.g., by comparing the lists, determining an intersection of the list, etc.).

In a second variation, the participating node monitor can obtain the blockchain event participant set from an offchain source, such as a blockchain explorer, and identify the managed nodes participating in the blockchain event as discussed above.

In a third variation, the participating node monitor can query each monitored node to determine the node's participation state. For example, the participating node monitor can query a node to determine whether the node is acting as an event participant.

In a fourth variation, the participating node monitor can monitor the participating nodes identified by the event monitor. In a first embodiment, the participating node monitor the participating managed nodes themselves. In a second embodiment, the participating node monitor can monitor the participating managed nodes on-chain, by requesting node parameters for the participating managed nodes from the blockchain or other nodes in the same blockchain.

However, the participating node monitor can otherwise monitor node participation in the blockchain event.

The optional reset module can reset the computing resource allocation to each node once the node is no longer associated with a blockchain event (e.g., no longer participating in the blockchain event). The reset module can reset the computing resource allocation by: setting the node priority to a predetermined priority, allocating a predetermined amount of computing resources to the node, by releasing computing resource constraints on the node (e.g., letting other services, such as the kernel, determine the computing resource priority), and/or otherwise reset the computing resource allocation.

However, the management system can include any other suitable set of modules.

### 5. Method.

As shown in FIG. 1, the method for blockchain node management can include: identifying a set of managed nodes S100; determining blockchain data indicative of a blockchain event S300; determining managed node participation in the blockchain event S500; dynamically allocating resources to the participating managed nodes S700; and resetting node resources for nonparticipating nodes S900. However, the method can be otherwise performed. The method is preferably performed using the management system 100 discussed above, but can alternatively be performed using any other suitable management system. All or a portion of the method can be iteratively performed, performed once, or performed any number of times. All or a portion of the method can be performed in any suitable order.

The method can be performed for all managed nodes 30 (e.g., iteratively, at a predetermined frequency, at a block generation frequency, etc.), a subset of managed nodes, and/or any other suitable set of nodes. The method can be performed for all blockchains for each managed node, a subset thereof, and/or any other suitable set of blockchains. The method can be performed for all user accounts, a subset of user accounts, and/or any other suitable set of user accounts. The method can be performed for all managed computing resource sets, a subset thereof, and/or any other suitable set of computing resource sets.

Identifying a set of managed nodes S100 functions create an index of nodes and/or space instances that could potentially consume computing resources that are managed by and/or controllable by the management system 100. S100 can be performed continuously, when a new space instance is created or registered to the control plane, at a predetermined frequency, when an event occurs, when a query is sent, when information is propagated from the node to a control plane, and/or at any other time. S100 can be performed by: the node indexer, the space instance indexer, and/or any other suitable module. The nodes 30 can be identified by: a blockchain node identifier, a process identifier, a space instance identifier, and/or any other node identifier. The information that can be stored include: the node identifier, the node's blockchain, the node's parameter values, and/or any other suitable information. In a first variant, S100 includes registering the nodes to a control plane (e.g., using a daemon executing in the node's space instance 50). In a second variant, S100 includes identifying all processes consuming or requesting computing resources from the machine. In a third variant, S100 includes querying each registered space instance for the nodes hosted by the respective space instance. In a fourth variant, S100 includes receiving the managed nodes from a user. In a fifth variant, S100 includes requesting resource information for the blockchain nodes of a blockchain (e.g., via a node of the blockchain), and identifying managed nodes as blockchain nodes having resource identifiers associated with the managed computing resources. For example, S100 can include requesting a peerbook from the blockchain and identifying managed nodes as those having the computing resource set's IP address. However, S100 can be otherwise performed.

The method can optionally include determining the state of each node, which can be used to determine whether the node is participating in a blockchain event, determine the probability of node election for participation in the blockchain event, and/or otherwise used. The node state can be determined by one or more node state modules. The state of each node can be determined: contemporaneously, concurrently (e.g., at the same time), independently, at a predetermined frequency (e.g., based on the blockchain event frequency, query frequency, etc.), responsive to event occurrence (e.g., imminent blockchain event detected, probability of node selection for participation exceeding a threshold, etc.), and/or at any other suitable time, with any other suitable relationship to other nodes. The state of each node (node state) can be characterized by a set of node parameter values, or be otherwise determined. Node parameters can include: block height, node stability, last synchronization with the blockchain, staked amount, network version, and/or any other node parameter. Different nodes (e.g., even those for the same blockchain running on the same machine) can have different node parameter values. For example, nodes hosted by the same machine can have different block heights because they synchronized with the blockchain differently, due to differences in computing resource allocation. The node state can be determined by the node state module or by any other module. In a first variation, the node state can be determined by querying the node. In a second variation, the node state can be determined by evaluating a log and/or other telemetry. For example, the node state can be determined based on the last set of event in the log. In an illustrative example, the node can be in a consensus state when the logged event maps to consensus participation. The log is preferably for the node itself, but can alternatively be for the blockchain. The log can be generated by the node, the space instance, and/or by any other component. In a third variation, the node state is received from a user. However, the node state can be otherwise determined.

Determining blockchain data indicative of a blockchain event S300 (e.g., introspecting the blockchain) functions to determine that a blockchain event is about to happen, determine when a blockchain event will happen, determine that a blockchain event is happening, and/or determine that a blockchain event has occurred. The blockchain event detected using S300 can be: an upcoming blockchain event (e.g., the next blockchain event, a blockchain event expected to occur a predetermined number of events in the future, etc.), an ongoing blockchain event, a past blockchain event (e.g., the last blockchain event, a blockchain event occurring a predetermined number of events ago, etc.), and/or any other suitable blockchain event. In a first variant, this information is used to detect the blockchain event. In a second variant, this information is used to determine the query frequency for additional blockchain data (e.g., to ensure that the blockchain event is detected as early as possible). In a third variant, this information is used to dynamically allocate computing resources. However, the information can be otherwise used.

The blockchain data can be determined by: the event indexer, a blockchain explorer, and/or any other management system. The blockchain data can be determined from: one or more managed nodes, unmanaged nodes (e.g., when a blockchain explorer is used), and/or any other suitable set of nodes. When the blockchain data is determined from multiple nodes, conflicting values can be resolved by: voting, using the value from the node with the tallest block height (e.g., the most up-to-date node), and/or otherwise resolved. The blockchain data can be obtained by: querying a node, querying the blockchain (e.g., via a node), querying an offchain resource (e.g., a blockchain explorer), inferring the data (e.g., from historical data, from events appearing in the node logs, etc.), and/or otherwise obtained.

S300 can be performed: periodically (e.g., at the block generation rate or a fraction thereof); at a varying frequency (e.g., more frequently with temporal, block position, or transaction position proximity to the next blockchain event); constantly; randomly; and/or at any other time. S300 can be performed asynchronously from S100, during S100, after S100, or before S100. S300 can be performed before S500 (e.g., wherein the participating managed nodes are determined based on the blockchain data from S300), during S500, before S500, asynchronously from S500, and/or at any other suitable time relative to S500. In variants, because the act of querying the blockchain via the managed node can consume computing resources, the query frequency can be selectively adjusted based on estimated proximity to the blockchain event (e.g., increased with proximity). Additionally or alternatively, the queries can be sent to a “sacrificial” managed node (e.g., on the same or different machine) that is treated as a low-probability consensus candidate. However, the blockchain queries can be sent at any other suitable frequency to any other suitable set of blockchain nodes.

The blockchain data can include: whether the blockchain event is happening; when the next blockchain event will occur (e.g., the block ID, slot ID, epoch ID, wall clock time, and/or other identifier for the next consensus, consensus node selection, block proposal, block validation, block confirmation, and/or other blockchain event, etc.); the node identifiers (e.g., blockchain node identifiers) for nodes currently participating in the blockchain event; the node identifiers for nodes selected for participation in the blockchain event (e.g., elected validator nodes); blockchain parameters (e.g., block height, transactions per second, block time or confirmation time, etc.); and/or any other suitable data.

In a first variation, S300 includes querying one or more managed nodes for the blockchain data.

In a second variation, S300 includes inferring the blockchain data from a node's log data. For example, the node's log can exhibit a signature set of logs (e.g., function calls, variable values, resource requests, events, etc.) when the node is selected as a participating node or is actively participating in the blockchain event (e.g., consensus). In another example, the node's log can exhibit a signature set of logs (e.g., function calls, variable values, resource requests, events, etc.) leading up to a blockchain event (e.g., associated with the blockchain event, associated with an upcoming blockchain event, etc.). The signatures can be learned, manually determined, specified by the node's blockchain protocol, or otherwise determined.

In a third variation, S300 includes querying a blockchain explorer for the blockchain data, wherein the blockchain explorer determined the blockchain data from a set of unmanaged nodes.

In a fourth variation, S300 includes inferring the blockchain data from a schedule. For example, Cardano's election period and/or consensus period occurs once every second, so the blockchain event can be assumed to occur every second.

However, S300 can be otherwise performed.

Determining managed node participation in the blockchain event S500 functions to identify that a managed node, sharing computing resources with other managed nodes, either needs more computing resources or needs to maintain a preferential computing resource allocation.

S500 can be performed: a predetermined period before the blockchain event is to occur, when the blockchain event occurs, after the blockchain event is identified (e.g., in S300), at a predetermined frequency (e.g., 180 seconds, 90 seconds, at the block generation rate or a fraction thereof, etc.), at a variable rate (e.g., at a first frequency when a managed node is participating, at a second frequency when no managed nodes are participating, etc.), as part of S300, and/or at any other time. S500 can be performed at the same or different times (e.g., frequencies) for different blockchains (e.g., example shown in FIG. 7), different individual nodes, different node types, different user accounts, and/or otherwise performed. S500 can be performed for one or more nodes at the same time. S500 can be iteratively performed for each node, performed once for each event, iteratively performed until the node is a confirmed participant, and/or performed any number of times. S500 can be performed at different times (e.g., frequencies) based on the blockchain's proximity to the next blockchain event, based on the node's probability of being selected for the next blockchain event, and/or otherwise performed. For example, S500 can be iteratively performed at a first frequency leading up to a blockchain event, performed at a second, lower frequency during the blockchain event (e.g., to confirm continued managed node participation in the event), and performed as a third, lower frequency after the blockchain event (e.g., lower than the second frequency, since the probability of the blockchain's nodes immediately reentering consensus will be low). However, S500 can be performed at any suitable time for any suitable set of nodes.

S500 can determine that the managed node will be participating in an upcoming blockchain event (e.g., future participant), determine that the managed node is actively participating in an ongoing blockchain event (e.g., current participant), and/or determine any other suitable participation state for the managed node. S500 can be performed by the event monitor, the participating node monitor, and/or by any other suitable management system. S500 can be determined by: comparing a participating node list for the event instance (e.g., determined from the blockchain) and the managed node list; by analyzing the managed node's logs or telemetry; by estimating that the managed node is a participant; or otherwise determined (e.g., examples shown in FIG. 8).

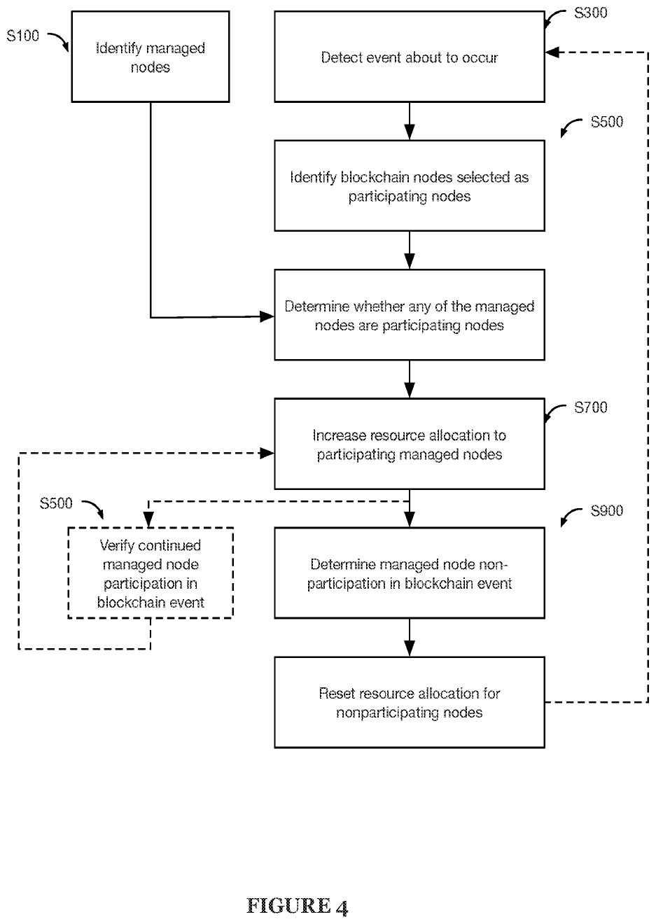

In a first variation, S500 includes determining that a managed node has been selected as a participating node (e.g., consensus node; example shown in FIG. 4). The managed node can be selected as a participating node for the current blockchain event, an upcoming blockchain event (e.g., the next event, a future event, etc.), and/or for any other suitable blockchain event. In a first embodiment, the first variation includes: retrieving a list of blockchain nodes elected as participating nodes for the next blockchain event (e.g., including unmanaged nodes); and determining whether a managed node is in the list. This is preferably performed using the managed node's blockchain node identifier, but can alternatively be performed using the managed node's process identifier, managed node's machine identifier (e.g., IP address), or other identifier. The list of blockchain nodes can be retrieved from: the participating managed node, another managed node (e.g., connected to the same blockchain), an unmanaged node (e.g., connected to the same blockchain), an offchain resource (e.g., a blockchain explorer), and/or any other suitable data source. In a second embodiment, the first variation includes querying each managed node to determine whether it has been selected as a participating node (e.g., using consensus protocols similar to the Algorand protocol). In a third embodiment, the first variation includes monitoring messages (e.g., logs, telemetry, etc.) generated by the managed nodes, and identifying the managed node as a participating node when the messages include values indicative of blockchain event participation. For example, the messages can: exhibit a pattern associated with event participation; include values associated with event participation (e.g., a proof, such as a VRF proof; attestation that the node is a participating node; a message type associated with event participation; etc.); and/or be otherwise associated with event participation. However, a managed node can be otherwise identified as a participating node.

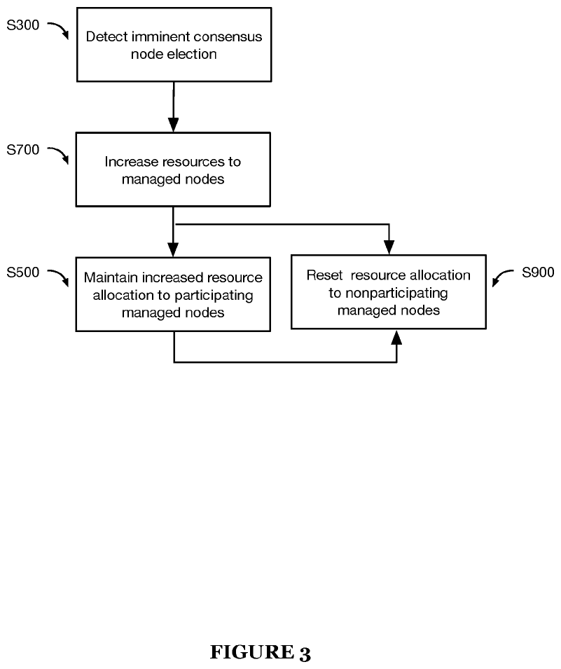

In a second variation, S500 determines the probability that a managed node will be selected as a participating node (e.g., may be a consensus node) in an upcoming event (e.g., the next event, a future event, etc.). High-probability nodes can be treated as participating nodes, be monitored more closely, or otherwise managed. Low-probability nodes can be treated as nonparticipating nodes, be monitored less closely (e.g., less frequently, less comprehensively, etc.), ignored, and/or otherwise managed. High probability nodes can be those with a selection probability higher than a threshold, a selection probability higher than a proportion of the other managed nodes, and/or otherwise determined. The node selection probability can be determined based on: temporal or block height proximity to the next blockchain event (e.g., consensus event); example shown in FIG. 3; based on the consensus mechanism's basis for the node (e.g., node's relative stake, node's available memory, node's available computing power, etc.); based on the duration since the node last participated in the event (e.g., intervening number of events, wall clock time, number of blocks, etc.); based on node parameter values, based on other nodes' parameter values, and/or otherwise determined. The other blockchain nodes can include managed and/or unmanaged nodes. The probability determination method can vary by blockchain, be fixed, or be otherwise determined. In a first embodiment, the node selection probability can be determined based on the node's stake relative to other blockchain nodes' stakes; the higher the node's relative stake, the higher the probability. In a second embodiment, the node selection probability can be determined based on the node's block height relative to other blockchain node heights; the taller the node's block height, the higher the probability. Additionally or alternatively, the node probability can be low or o if the node's block height is less than a threshold distance from the blockchain's current block height (e.g., the node has no chance of being selected). In a third embodiment, the node selection probability can be determined based on the last time it was selected as a participating node; the longer the period, the higher the probability. In a fourth embodiment, the node selection probability can be determined based on the amount of shared memory that could be allocated to the node (e.g., by taking the memory away from the other managed nodes); the higher the memory, the higher the probability. This fourth embodiment can be useful for proof-of-capacity blockchains. In a fifth embodiment, the node selection probability can be determined based on the proximity of the next event. For example, a node for a blockchain about to enter consensus can have a higher probability than a second node for a blockchain that just completed consensus. However, the node selection probability can be otherwise determined.

In a third variation, S500 includes determining that a node is currently participating in the blockchain event (example shown in FIG. 4). In a first embodiment, determining current node participation includes retrieving a list of current participating blockchain nodes (e.g., for the entire blockchain), and determining whether a managed node appears in the list (e.g., based on the managed node's blockchain identifier). In a second embodiment, current node participation is determined based on the node's logs or telemetry (e.g., the node is executing a predetermined set of functions associated with the blockchain event). In a third embodiment, current node participation is determined based on the node's resource demands. For example, a node can be classified as participating in the blockchain event when the node is maxed out on processing power or memory.

In a fourth variation, S500 includes determining that a node is no longer participating in the blockchain event. In a first embodiment, node participation cessation (e.g., node nonparticipation) includes receiving a blockchain output indicative of blockchain event termination. For example, the blockchain can emit an output indicating that the next block has been generated (e.g., mined, validated, confirmed, etc.). In a second embodiment, participation cessation is determined based on the node's resource demands. For example, the node can be classified as a nonparticipant when the node resource demand falls below a threshold (e.g., a global threshold, a blockchain-specific threshold, etc.). In a third embodiment, participation cessation is determined based on the node logs or telemetry (e.g., the node is no longer executing the blockchain event functions). In a fourth embodiment, participation cessation can be determined by retrieving a list of participating nodes (e.g., consensus nodes), and determining that the node is no longer in the list. The list can be retrieved from the blockchain (e.g., via a managed or unmanaged node), from an offchain source, and/or otherwise obtained. However, participation cessation can be otherwise determined.

However, managed node participation in the blockchain event can be otherwise determined.

Dynamically allocating resources to the participating managed nodes S700 functions to increase the allocation of shared computing resources to the participating managed nodes or maintain a node's allocated resources at an elevated level. The elevated level can be relative to the resources that the node would have received without management, be relative to other managed nodes (e.g., sharing the same computing resources), and/or be otherwise defined. This can divert computing resources from other, non-participating nodes sharing the same computing resources, or maintain the computing resource allocation to non-participating nodes. The computing resources can be preferentially allocated to the participating managed nodes or otherwise allocated. S700 is preferably performed after a managed node is identified as a participant in the blockchain event, but can be performed before. S700 can be performed before the blockchain event, when the blockchain event starts, and/or at any other suitable time relative to the blockchain event. For example, S700 can be performed when a consensus node election is about to happen, which can (for some consensus protocols) maximize the probability of all or a subset of the managed nodes being selected as participating nodes. In another example, S700 can be performed when the node has been confirmed as a participating node. In another example, S700 can be performed as long as the node remains a participating node.

The timing for when S700 is performed can be determined based on the respective node's blockchain (e.g., rules specific to the blockchain, rules determined based on the blockchain's consensus mechanism, etc.), be performed based on a set of default rules, be determined based on node resource requests, and/or otherwise determined. For example, increased computing resources can be allocated to nodes of a first blockchain prior to consensus participant election, while increased computing resources are allocated to nodes of a second blockchain

S700 preferably assigns resources using the participating managed node's process identifier, but can alternatively use the identifier for the space instance hosting the participating managed node, and/or use any other identifier. S700 can be performed by the management system managing the computing resource set (e.g., hypervisor, supervisor, etc.), by a module, by the kernel, and/or by any other suitable component.

S700 preferably allocates computing resources in real- or near-real time, such that the nodes are allocated the resources immediately or after a short delay. Additionally or alternatively, S700 can schedule future computing resource allocation for one or more nodes. For example, S700 can schedule a node's process priority to be set to high (e.g., “−10”) at a predetermined time, before or starting at the time when the blockchain event for the node's blockchain is estimated to occur.

S700 can allocate resources by controlling the node's priority (e.g., process priority, computing resource priority, etc.), by controlling the amount of resources explicitly assigned to the node, by using a pool-based approach, by using a resource partitioning approach, and/or otherwise allocate resources. S700 can allocate physical computing resources (e.g., physical threads, physical memory spaces, etc.), virtual computing resources (e.g., virtualized processing units, virtual threads, virtual memory spaces, etc.), and/or any other suitable computing resource or representation thereof.

The targets and/or thresholds used to control node resource allocation (e.g., the priority target, priority threshold or threshold priority, the resource allocation target, resource allocation threshold or threshold resource allocation, etc.) can be: determined based on the node's demands, determined based on the node's blockchain (e.g., based on what is needed to participate in the event for the node's blockchain, a predetermined value for the blockchain, etc.), determined based on the return on resource investment in the node (e.g., absolute monetary return, relative monetary return relative to other nodes), determined based on a preference score for the node (e.g., determined based on the participation probability, estimated return, estimated opportunity loss for the allocated computing resources, etc.), determined based on user preferences, determined based on the node's participation probability, determined based on other nodes' demands, and/or determined based on any other suitable set of information. The targets and/or thresholds can be specific to a computing resource type or be generic across computing resource types. The targets and/or thresholds used to control node resource allocation can be: looked up, default values, calculated (e.g., using an optimization), be specific to a blockchain, and/or otherwise determined. In variants, the management system can optionally prioritize participating managed nodes when insufficient computing resources are available, based on the preference score, the remaining blockchain event duration, a vote, the anticipated return (e.g., monetary return), an optimization, and/or otherwise prioritized. The targets and/or thresholds can be used to determine the amount of allocated computing resource, set a floor for computing resource allocation, set a cap or ceiling for computing resource allocation, and/or be otherwise used.

The types of computing resources allocated to participating managed nodes can be: determined based on the blockchain event's resource requirements (e.g., specific to the respective blockchain); be a default set of resource requirements; be automatically determined by the node process; and/or be otherwise determined. For example, an increased amount of GPU resources (e.g., physical or virtual GPU) can be allocated to participating managed nodes of blockchains with compute-intensive consensus mechanisms while a minimum amount of allocated memory to said participating managed nodes is maintained; and an increased amount of allocated memory can be allocated to participating managed nodes of blockchains with memory-intensive consensus mechanisms (e.g., proof-of-capacity blockchains) while a minimum amount of processing power is allocated. In another example, the S700 sets the participating managed nodes' process priorities, wherein the participating managed nodes automatically determine which resources and the amount of said resources. However, which computing resources are allocated to participating managed nodes can be otherwise determined.

In a first variation, S700 includes setting the participating managed node's resource allocation to participating resource values. Setting the resource allocation can include: setting the resource allocation to a predetermined value, increasing the resource allocation above a threshold allocation, and/or otherwise setting the resource allocation. For example, the participating managed node can be assigned: a predetermined number of threads (e.g., 6, 8, 10, etc.), a predetermined amount of memory (e.g., 1 mb, 10 mb, 100 mb, 500 mb, 1 gb, etc.), a predetermined amount of compute time (e.g., processor time), and/or any other set amount of computing resource. The target amount of computing resource can be: predetermined, calculated based on other blockchain node's computing resources, determined based on the blockchain protocol (e.g., enough memory to guarantee winning the consensus), or otherwise determined.

In a second variation, S700 includes setting the participating managed node's process priority (e.g., preferential allocation), wherein the kernel can dynamically allocate resources based on the priorities for all nodes sharing the kernel. Setting the process priority can include: setting the process priority to a predetermined value, increasing the process priority above a threshold priority, and/or otherwise setting the process priority. For example, S700 can include setting the participating managed node's process priority to high (e.g., “−10” when using a linux-based management system). The target priority can be: a default value (e.g., “−10”), a dynamically determined value (e.g., determined based on the participation state of other nodes), a user-determined value (e.g., wherein the user specifies the participating managed node process priorities for a set of nodes), and/or be otherwise determined.

In a third variation, S700 includes requesting more computing resources (e.g., more machines, more processors, etc.) from a computing provider, such as a cloud computing provider, and providing the additional resources to the nodes.

In a fourth variation, S700 includes assigning a participating node profile to the participating managed node, wherein the machine (and/or kernel) can allocate resources to the participating managed node based on the participating node profile. When profiles are used, the profiles can specify: target computing resource allocation values, target priorities, and/or any other suitable parameter. For example, the participating node profile can include: a high process priority (e.g., “−10”), a high number of threads (e.g., 6, 8, 10, 12, 30, or more threads; etc.), a large amount of memory (e.g., 100 MB, 1 GB, 10 GB, etc.), 1x, 2x, 3x, 4x, 5x, and/or any other multiple of the default profile's values, and/or any other suitable value.

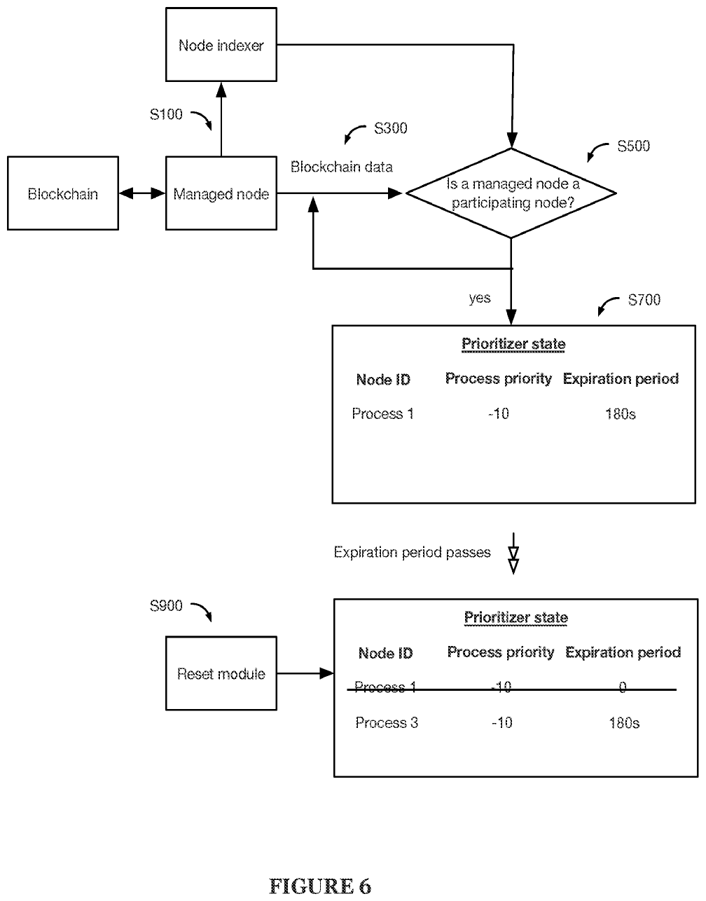

In an example (e.g., shown in FIG. 6), when the node is identified as a participating node, the node identifier (e.g., process identifier) can be written to a table (e.g., a prioritizer state), with a predetermined expiration time (e.g., 180 seconds). The entry can be renewed as long as the participating managed node is confirmed to be a participant in the blockchain event.

However, resources can be otherwise allocated to the participating managed nodes.

Resetting node resources for nonparticipating nodes S900 functions to de-allocate computing resources from non-participating managed nodes. This can free up resources for other participating managed nodes, for other nodes to synchronize with the blockchain, for other nodes to respond to external queries, for other nodes to receive and broadcast transactions, and/or for any other suitable node activity. S900 can be performed periodically (e.g., at the blockchain's block generation rate or fraction thereof, at a default frequency, etc.), upon occurrence of a reset condition (e.g., timer expiration, when a blockchain event ends, when a node is no longer confirmed as a participating node, etc.), responsive to manual intervention, and/or at any other time. S900 can be performed by the reset module or by any other management system.

The resources can be explicitly reset (e.g., explicitly setting the process priority to a lower priority target, explicitly assigning a lower amount of computing resources to the node, etc.), reset by default (e.g., wherein the higher process priority or resource allocation peg expires, etc.), implicitly reset (e.g., wherein other nodes are assigned even higher priorities or resource allocations), and/or otherwise reset.

The resources can be reset by: setting the previously-participating nodes' resource values to default values (e.g., 1, 2, or 3 threads; 10 MB, 50 MB, setting a maximum amount of memory, etc.); releasing the node priority peg; releasing the node resource allocation peg; removing the participating node profile from the node; resetting the previously-participating nodes' priority to be free floating or a lower priority (e.g., “20”, “O”, wherein the kernel handles computing resource allocation based on the new process priority); assigning a default profile to the previously-participating node; and/or otherwise resetting the resources.

In an example (e.g., shown in FIG. 6), when the node identifier is written to a table (e.g., the prioritizer state), the table can be periodically checked for expired entries, wherein the reset module can reset the resources for the expired node identifiers as discussed above.

However, the node resources can be otherwise reset.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A system, comprising:
a set of shared computing resources;
a set of blockchain nodes executing on the set of shared computing resources; and
a management system that preferentially allocates computing resources from the set of shared computing resources to participating blockchain nodes, from the set of blockchain nodes, participating in blockchain consensus on a blockchain associated with the respective blockchain node.

2. The system of claim 1, wherein preferentially allocating computing resources to a participating blockchain node comprises increasing a computing resource priority for the participating blockchain node.

3. The system of claim 1, wherein the management system identifies the participating blockchain nodes by:
determining a set of consensus participants for each of a set of blockchains associated with the set of blockchain nodes; and
identifying blockchain nodes from the set of blockchain nodes within the sets of consensus participants.

4. The system of claim 1, wherein the participating blockchain nodes are participants in an upcoming blockchain consensus, wherein the computing resources are allocated to the participating blockchain nodes before the upcoming blockchain consensus.

5. The system of claim 1, wherein each blockchain node executes in a different virtual machine executing on the set of shared computing resources, wherein the management system preferentially allocates computing resources from the set of shared computing resources to the respective virtual machine executing the participating blockchain nodes.

6. The system of claim 1, wherein the management system reallocates the computing resources when consensus is complete.

7. The system of claim 1, wherein the set of shared computing resources comprises a set of virtualized physical resources.

8. The system of claim 1, wherein the blockchain nodes within the set of blockchain nodes are associated with different blockchains.

9. The system of claim 1, wherein the management system comprises a hypervisor.

10. A system managing a set of computing resources hosting a set of blockchain nodes, wherein the system is configured to:
identify a set of participating blockchain nodes, from the set of blockchain nodes, participating in a blockchain event on a blockchain of the respective blockchain node; and
preferentially allocate computing resources to the set of participating blockchain nodes.

11. The system of claim 10, wherein the blockchain event comprises blockchain consensus.

12. The system of claim 10, wherein the set of participating blockchain nodes are identified by:
determining a set of activity blockchain nodes for each of a set of blockchains associated with the set of blockchain nodes; and
identifying the participating blockchain nodes based on an overlap between the set of blockchain nodes and the sets of activity blockchain nodes.

13. The system of claim 10, wherein the set of computing resources comprises a set of shared physical resources.

14. The system of claim 10, wherein the set of computing resources are from a single bare metal machine.

15. The system of claim 10, wherein the computing resources are preferentially allocated to the set of participating blockchain nodes by assigning priorities above a threshold priority to each participating blockchain node.

16. The system of claim 10, wherein each blockchain node executes in a different virtual machine hosted on the set of computing resources, wherein the agent preferentially allocates computing resources from the set of computing resources to the respective virtual machine executing the participating blockchain nodes.

17. The system of claim 10, wherein a first blockchain node in the set of blockchain nodes is connected to an account-based blockchain, and a second blockchain node in the set of blockchain nodes is connected to a UTXO-based blockchain.

18. The system of claim 10, wherein the participating blockchain nodes are participants in an upcoming blockchain event, wherein the computing resources are allocated to the participating blockchain nodes before the upcoming blockchain event occurs.

19. The system of claim 10, wherein the blockchain nodes within the set of blockchain nodes are consensus nodes.

20. The system of claim 10, wherein the system is configured to reallocate the computing resources after the blockchain event is complete.
